(19) United States
(12) Patent Application Publication
(10) Pub. No.: US 2008/0273144 A1
(43) Pub. Date: Nov. 6, 2008

(54) DIFFUSING POLARIZER AND BACKLIGHT MODULE USING THE SAME

(75) Inventors: Po-Hung Yao, Kaohsiung County (TW); Yu-Nan Pao, Hsinchu County (TW); Yi-Ting Sun, Taipei City (TW); Ying-Hsiu Lin, Yilan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 11/858,113

(22) Filed: Sep. 19, 2007

(30) Foreign Application Priority Data
May 2, 2007 (TW) 96115632

(51) Int. Cl. G02B 5/02; F21V 99/00

(52) U.S. Cl. 349/64; 349/194

(57) ABSTRACT

A diffusing polarizer including a substrate and a microstructure layer is provided. The micro-structure layer includes a solid phase liquid crystal having a birefringence feature. The diffusing polarizer is capable of both polarizing and diffusing incident light beams. A backlight module using the diffusing polarizer is also provided.

### CROSS-REFERENCE TO RELATED APPLICATION

This application claims the priority benefit of Taiwan application serial no. 96115632, filed May 2, 2007. All disclosure of the Taiwan application is incorporated herein by reference.

### BACKGROUND OF THE INVENTION

1. Field of the Invention

The present invention generally relates to an optical film and a light source module using the same, in particular, to a diffusing polarizer and a backlight module using the same.

2. Description of Related Art

As electronic industries being rapidly developed, flat panel displays have taken in place of the cathode ray tube (CRT) displays in the market and become a mainstream therein. Among several kinds of typical flat panel displays, liquid crystal displays (LCD) are most well-developed and popular. Since LCD panels do not emit light by themselves, backlight modules are usually provided under the LCD panels for providing a light source for displaying.

FIG. 1 is a cross-sectional view of a conventional backlight module. Referring to FIG. 1, a backlight module 100 includes a plurality of light sources 110, a plurality of optical films 120, and a reflector 130. The light sources 110 are disposed in the reflector 130. The light sources 110 and the optical films 120 are assembled in the reflector 130. Light beams emitted from the light sources 110 are configured into a uniform plane light source after passing through the optical films 120.

Conventional optical films usually include a diffusing plate and a brightness enhancement film (BEF). The diffusing plate is adapted for evening incident light beams, and the brightness enhancement film is adapted for concentrating the light beams so as to improve on-axial brightness of the light source.

Further, a typical brightness enhancement film may be featured as having birefringence. Such a brightness enhancement film is adapted to allow incident light beams having a specific polarizing direction passing therethrough, while reflecting light beams having other polarizing direction for reusing. In such a way, more light beams can be guided into the LCD panel. However, conventional brightness enhancement films are configured by alternately stacking a plurality of materials of different refractive indices to obtain birefringence. Unfortunately, the thickness and the manufacturing process of such a brightness enhancement film configured by a plurality of film layers cause high cost. Further, when the light beams passing through interfaces between different material layers of the film stack, a loss of the light beams occur, so that the efficiency of the light sources is decreased. Additionally, the production yield rate of the brightness enhancement film configured by the plurality of film layers is accordingly limited.

### SUMMARY OF THE INVENTION

Accordingly, the present invention is directed to diffusing polarizer for polarizing and evening incident light beams.

The present invention is also directed to a backlight module using the foregoing diffusing polarizer.

The present invention provides diffusing polarizer. The diffusing polarizer includes a substrate, and a microstructure layer. The microstructure layer is disposed on the substrate. The microstructure layer includes a solid-phase liquid crystal material having a birefringence feature.

The present invention further provides a backlight module. The backlight module includes a plane light source structure and a diffusing polarizer. The plane light source structure has an output surface. The diffusing polarizer is disposed upon the output surface of the plane light source structure. The diffusing polarizer includes a substrate, and a microstructure layer. The microstructure layer is disposed on the substrate. The microstructure layer includes a solid phase liquid crystal material having a birefringence feature.

The diffusing polarizer according to the present invention uses a birefringent solid phase liquid crystal material such that the birefringence of the diffusing polarizer can be achieved without requiring multi-layer structure as the prior art of aforesaid brightness enhancement film. When such a diffusing polarizer is used in a backlight module, the number, thickness and weight of the optical films used in the backlight module can be reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a conventional backlight module.

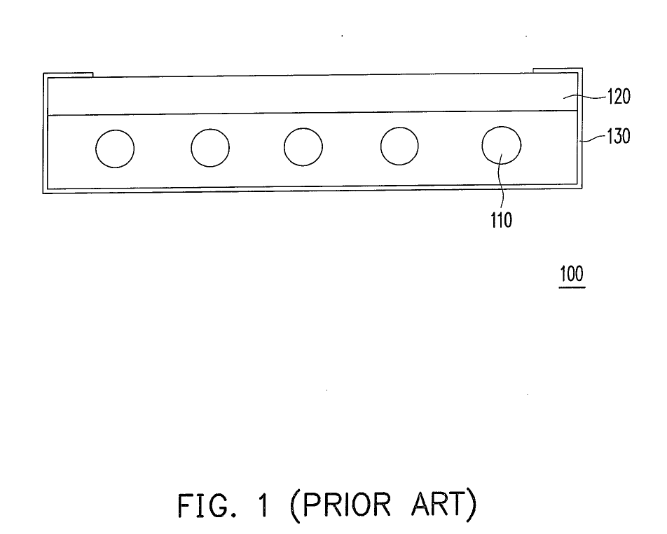

FIG. 2 is a cross-sectional view of a diffusing polarizer according to an embodiment of the present invention.

FIG. 3 is a cross-sectional view of a diffusing polarizer of another embodiment according to the present invention.

FIG. 4 is schematic diagram illustrating the distribution of protrusions of FIG. 2.

FIGS. 5 and 6 are cross-sectional views of protrusions of FIG. 2 according to other embodiments of the present invention.

FIGS. 7 through 9 illustrate other alternative distributions of protrusions of FIG. 2.

FIG. 10 is a cross-sectional view of a backlight module according to an embodiment of the present invention.

FIG. 11 is a cross-sectional view of a backlight module according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

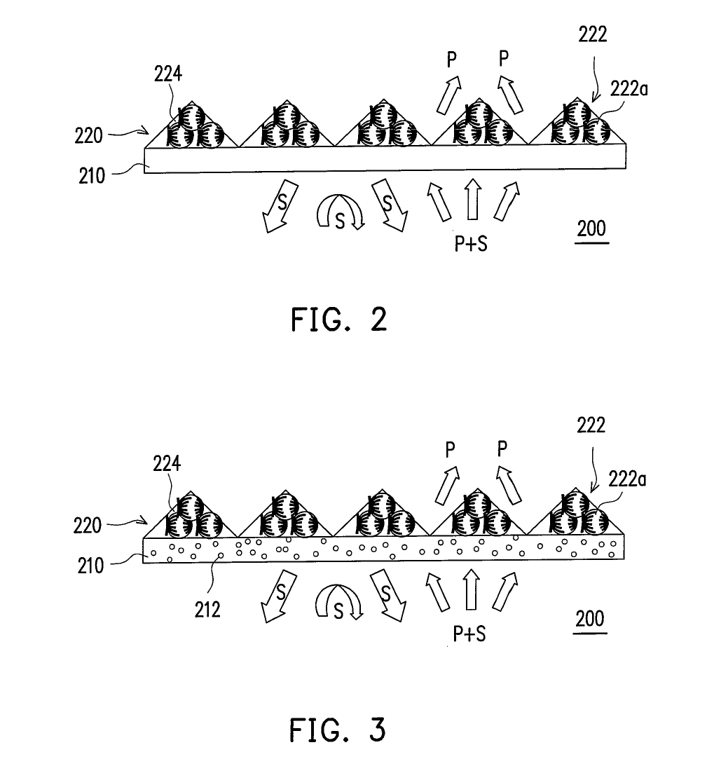

FIG. 2 is a cross-sectional view of a diffusing polarizer according to an embodiment of the present invention. Referring to FIG. 2, a diffusing polarizer 200 is illustrated. The diffusing polarizer 200 includes a substrate 210, and a microstructure layer 220 disposed on the substrate 210. The microstructure layer 220 includes a solid-phase liquid crystal material 222. The substrate 210 may be made of polyethylene terephthalate (PET), polymethyl methacrylate (PMMA), polycarbonate (PC), polystyrene (PS), or the like. The microstructure layer 220 may be made of an ultraviolet curable material. The solid-phase liquid crystal material 222 may include polymer dispersed liquid crystal drops 222a fabricated by dispersing liquid crystal molecules into polymer. The polymer dispersed liquid crystal drops 222a are aligned in accordance with proper design of the microstructure layer 220, so that the microstructure layer 220 can obtain a birefringence feature. The microstructure layer 220 is then cured by ultraviolet so as to accomplish the alignment procedure of the polymer dispersed liquid crystal drops 222a. Further, according to other aspects of the embodiment, an external electric field or an external alignment force may be applied to enhance the alignment of the polymer dispersed liquid crystal drops 222a.

The solid-phase liquid crystal material 222 of the diffusing polarizer 200 is featured in birefringence. Therefore, the diffusing polarizer 200 allows light beams having a specific polarizing direction passing therethrough, while reflecting light beams having other polarizing directions. In such a way, the diffusing polarizer 200 has a function of polarizing light beams incident thereto. In this manner, only one piece of diffusing polarizer 200 of the present invention can achieve functionalities of a reflective polarizer and a diffuser.

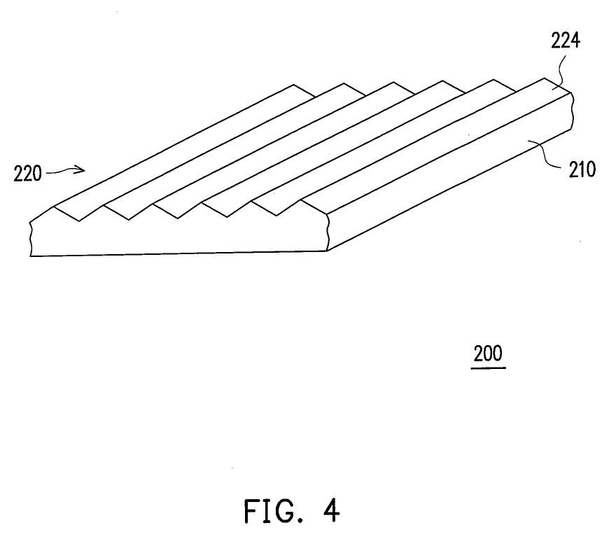

FIG. 3 is a cross-sectional view of a diffusing polarizer of another embodiment according to the present invention. Referring to FIG. 3, in this embodiment, the substrate 210 of a diffusing polarizer 200 includes a plurality of diffusing particles 212 distributed therein, such that the uniformity of the light beams passing through the diffusing polarizer 200 is enhanced. The microstructure layer 220 further includes a plurality of protrusions 224. The protrusions 224 are adapted for concentrating the light beams passing through the diffusing polarizer 200, thus improving the on-axial brightness of the light beams.

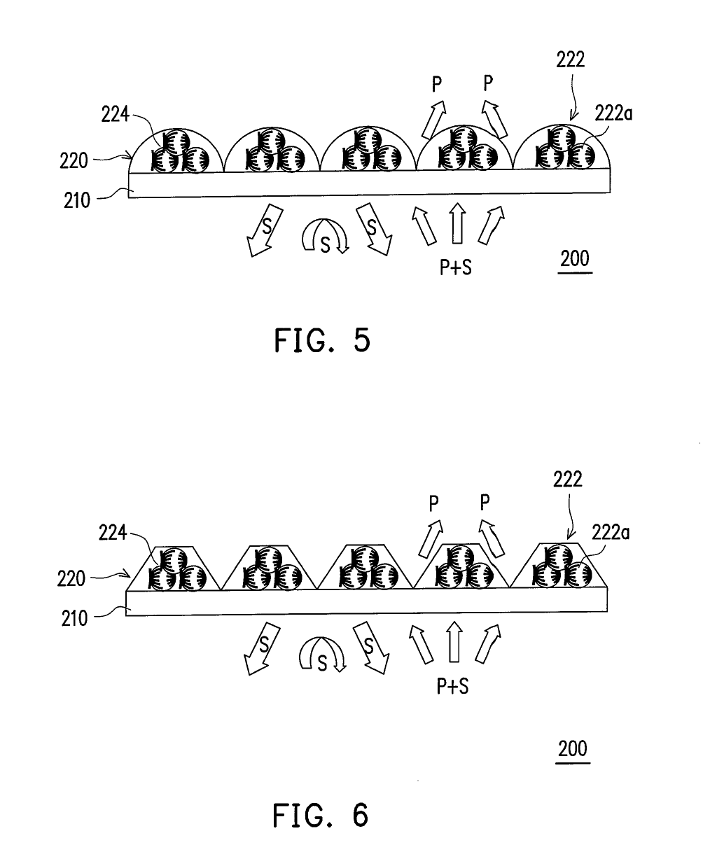

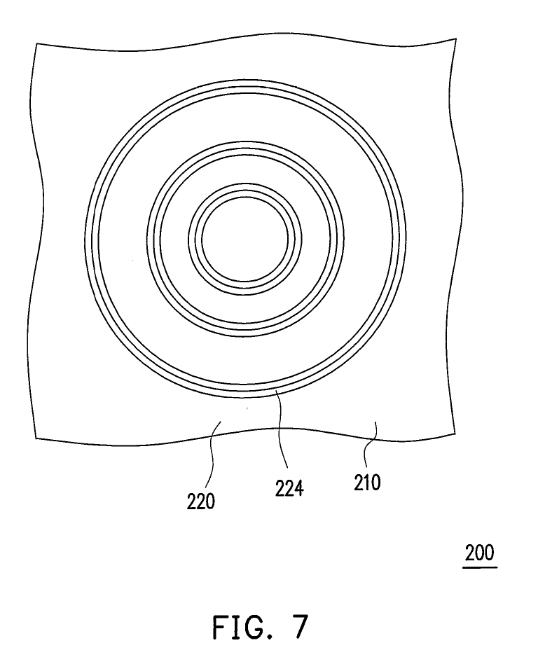

FIG. 4 is schematic diagram illustrating the distribution of protrusions 224 of FIG. 2. Referring to FIGS. 2 and 4, the protrusions 224 as shown in FIG. 4 are strip shaped and distributed in a grating form. As shown in FIG. 2, each of the protrusions 224 has a triangular vertical cross-section. However, the present invention is not limited to the shape, form of the protrusions 224 disclosed above. FIGS. 5 and 6 are cross-sectional views of protrusions of FIG. 2 according to other embodiments of the present invention. Referring to FIGS. 5 and 6, the microstructure layer 220 has a semi-elliptical vertical cross-section as shown in FIG. 5, while the microstructure layer 220 has a trapeziform vertical cross-section as shown in FIG. 6.

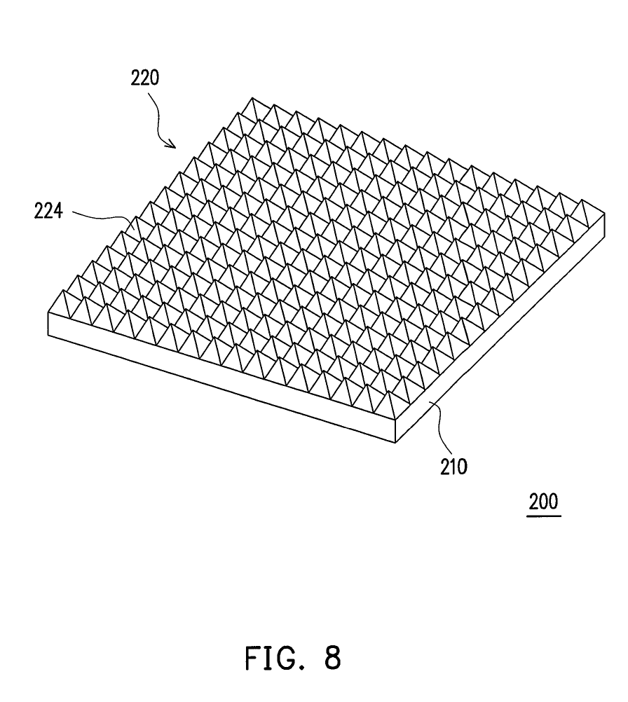

However, the protrusions 224 are not necessarily limited to be strip shaped. FIGS. 7 through 9 illustrate other alternative distributions of protrusions of FIG. 2. As shown in FIG. 7, the protrusions 224 are annular shaped and distributed in a form of concentric circles. As shown in FIG. 8, the protrusions 224 are cone shaped and distributed regularly. As shown in FIG. 9, the protrusions 224 are also cone shaped while distributed irregularly. It should be noted that although pyramid cones are shown in FIGS. 8 and 9 for illustrating the protrusions 224, those of ordinary skill in the art may modify shapes of the protrusion as required. For example, the protrusions 224 may be taper cones.

It should be noted that diffusing particles as disclosed in the foregoing embodiments (shown in FIG. 3) can be added into the substrate of the diffusing polarizers shown in FIGS. 4-9 for enhancing diffusing effect.

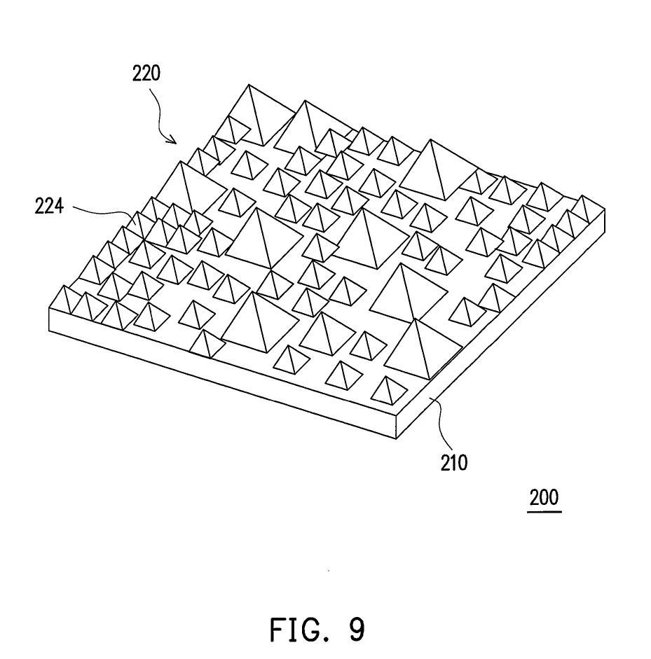

The present invention also provides a backlight module using the foregoing described diffusing polarizer. FIG. 10 is a cross-sectional view of a backlight module 300 according to an embodiment of the present invention. Referring to FIG. 10, the backlight module 300 includes a plane light source 310, and a diffusing polarizer 200 as disclosed above. The plane light source 210 has an outputting surface 310a, and the diffusing polarizer 200 is disposed on the outputting surface 310a.

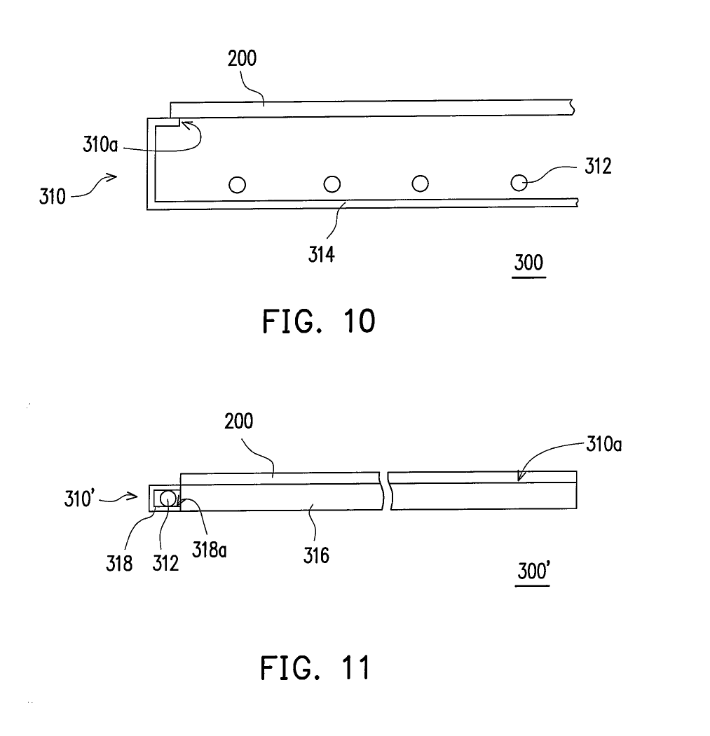

According to an aspect of the embodiment, the plane light source 310 is a direct type light source including a plurality of light emitting devices 312, and a reflector 314, for example. The light emitting devices 312 are disposed in the reflector 314. According to another aspect of the embodiment, the plane light source 310 for example is an edge type light source. FIG. 11 is a cross-sectional view of a backlight module 300′ according to another embodiment of the present invention. Referring to FIG. 11, a plane light source 310′ of the backlight module 300′ is an edge type light source including a light emitting device 312, a light guide plate 316, and a lamp cover 318. The light emitting device 312 is disposed in an accommodating space 318a of the cover 318. The light emitting device 312 may be an organic electro-luminescent device, cold cathode fluorescent lamp (CCFL), or a light emitting diode (LED).

In summary, because the solid-phase liquid crystal material of the diffusing polarizer is featured in birefringence, it allows incident light beams having a specific polarizing direction passing therethrough, while reflecting light beams having other polarizing directions. Therefore, the diffusing polarizer is adapted for polarizing light beams incident thereto. The diffusing polarizer reflects incident light beams randomly, so that it can uniform the reflected light beams. Further, the microstructure layer includes a plurality of protrusions, by which the diffusing polarizer is adapted for concentrating light beams. When such a diffusing polarizer is used for a backlight module, only one piece of diffusing polarizer of the present invention can achieve functionalities of a reflective polarizer and a diffuser.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A diffusing polarizer comprising:
a substrate; and
a microstructure layer, disposed on the substrate, wherein the microstructure layer comprises a solid-phase liquid crystal material having a birefringence feature.

2. The diffusing polarizer according to claim 1, wherein the substrate comprises a plurality of diffusing particles distributed therein.

3. The diffusing polarizer according to claim 1, wherein the microstructure comprises a plurality of protrusions.

4. The diffusing polarizer according to claim 3, wherein the protrusions are strip shaped and distributed in a grating form.

5. The diffusing polarizer according to claim 4, wherein each of the protrusions has a triangular vertical cross-section.

6. The diffusing polarizer according to claim 4, wherein each of the protrusions has a trapeziform vertical cross-section.

7. The diffusing polarizer according to claim 4, wherein each of the protrusions has a semi-elliptical vertical cross-section.

8. The diffusing polarizer according to claim 3, wherein the protrusions are strip shaped and distributed irregularly in a grating form.

9. The diffusing polarizer according to claim 3, wherein the protrusions are annular shaped and distributed in a form of concentric circles.

10. The diffusing polarizer according to claim 3, wherein the protrusions are cone shaped and distributed regularly.

11. The diffusing polarizer according to claim 3, wherein the protrusions are cone shaped and distributed irregularly.

12. A backlight module, comprising:
a plane light source, having an outputting surface;
a diffusing polarizer, disposed on the outputting surface of the plane light source, the diffusing polarizer comprising:
a substrate; and
a microstructure layer, disposed on the substrate, wherein the microstructure layer comprises a solid-phase liquid crystal material having a birefringence feature.

13. The backlight module according to claim 12, wherein the substrate comprises a plurality of diffusing particles distributed therein.

14. The backlight module according to claim 12, wherein the microstructure comprises a plurality of protrusions.

15. The backlight module according to claim 14, wherein the protrusions are strip shaped and distributed in a grating form.

16. The backlight module according to claim 14, wherein each of the protrusions has a triangular vertical cross-section.

17. The backlight module according to claim 14, wherein each of the protrusions has a trapeziform vertical cross-section.

18. The backlight module according to claim 14, wherein each of the protrusions has a semi-elliptical vertical cross-section.

19. The backlight module according to claim 14, wherein the protrusions are annular shaped and distributed in a form of concentric circles.

20. The backlight module according to claim 14, wherein the protrusions are cone shaped and distributed regularly.

21. The backlight module according to claim 14, wherein the protrusions are cone shaped and distributed irregularly.

22. The backlight module according to claim 12, wherein the plane light source is a direct type light source or an edge type light source.

23. The backlight module according to claim 12, wherein the plane light source comprising at least one light emitting device.

24. The backlight module according to claim 23, wherein the light emitting device is an organic electro-luminescent device, a fluorescent flat lamp, cold cathode fluorescent tube, or a light emitting diode.
